(19) United States
(12) Patent Application Publication
(10) Pub. No.: US 2025/0165280 A1
(43) Pub. Date: May 22, 2025

(54) SYSTEM AND METHOD FOR MITIGATING THE EFFECTS OF PREEMPTION IN MULTITASKING SYSTEMS

(71) Applicant: Eric Allen Grant, Elk Grove, CA (US)

(72) Inventor: Eric Allen Grant, Elk Grove, CA (US)

(21) Appl. No.: 18/515,007

(22) Filed: Nov. 20, 2023

(51) Int. Cl. G06F 9/48

(52) U.S. Cl. CPC G06F 9/485

(57) ABSTRACT

A system and method for avoiding problems associated with locks and preemption. After interrupting a rollback section of user code, the kernel causes a roll back” to the first instruction in the section. After the interrupt, when control is returned to the interrupted user-level thread, execution resumes at the beginning of the rollback section, not the point where the interrupt occurred. After interrupting a rollforward section of the present invention, the kernel causes execution to “roll forward” through the section to the last instruction. That is, the kernel essentially suppresses interrupts within a rollforward section, delaying the servicing of any interrupt until the section completes. Spinlocks employing the techniques of the present invention have none of the disadvantages of traditional locks: they formally fit the definition of “lock-free” code.

### FIELD OF THE INVENTION

The present invention generally relates to systems and methods for operation of multicore, multithreaded, multitasking operating systems and more particularly to systems and methods for managing preemption in such systems.

### BACKGROUND OF THE INVENTION

A defining characteristic of contemporary computing devices, both general-purpose (e.g., laptops, desktops, servers) and specialized (e.g., smartphones), is that they have multiple CPUs (or cores) that enable multiple parallel threads of execution. US Patent Application Publication 2014/0282572 discloses a multicore (multiple CPU) system and a method for scheduling tasks on these multiple cores. Specifically, the method disclosed in this patent publication for assigning tasks comprises receiving a set of tasks, modifying a deadline for each task based on execution, ordering relationship of the tasks, ordering the tasks in increasing order based on the modified deadlines for the tasks, partitioning the ordered tasks using one of non-preemptive scheduling and preemptive scheduling based on a type of multicore processing environment, and assigning the partitioned tasks to one or more cores of a multicore electronic device based on results of the partitioning.

A defining characteristic of the operating systems that run on those devices, again both general-purpose (e.g., Linux, MacOS, Windows) and specialty (e.g., iOS, Android), is that they employ preemptive multitasking. In that paradigm, any user-level thread of execution may be preempted (or interrupted) at any time for an unbounded length of time.

U.S. Pat. No. 9,023,404 describes preemptive multitasking in a multiple processor environment. It describes an example of inter-processor interrupts (IPI) as preemptive time-sharing operating systems, which receive periodic timer interrupts, in response to which the operating system may perform a task switch on one or more of the processors to schedule a different task or process to execute on the processors. In Linux SMP (symmetric multi-processing), for example, the timer handling routine running on the processor that receives the timer interrupt not only schedules the tasks on its own processor, but also directs an interrupt to each of the other processors to cause them to schedule their tasks. Each processor has an architected interrupt mechanism, which the timer interrupt-receiving processor uses to direct an IPI to each of the other processors in the multiprocessor system.

A further known technique in multitasking systems is a thread using a lock on a shared resource, e.g., a shared memory space. When a thread requires uninterrupted use of the shared resource, e.g., to prevent corruption of the data in a shared memory, the thread places a lock on the shared resource such that no other thread can access that resource. One problem associated with the use of locks arises when a thread that holds a lock is preempted as discussed above. In such a situation, the system can potentially stall as other threads cannot execute because of the lock on the common resource.

Associated with lock procedures is a structure known as a spinlock. A spinlock structure is a low-level, mutual-exclusion synchronization primitive that spins while it waits to acquire a lock. On multicore computers, when wait times are expected to be short and when contention is minimal, a spinlock can perform better than other kinds of locks. Spinlocks are recommended for use when it is determined by profiling that the locking mechanisms are significantly slowing the performance of the program.

A spinlock may yield the time slice of the thread even if it has not yet acquired the lock. It does this to avoid thread-priority inversion, and to enable a garbage collector to make progress. When a spinlock us used, one must ensure that no thread can hold the lock for more than a very brief time span, and that no thread can block while it holds the lock.

### SUMMARY OF THE INVENTION

The present invention makes innovative use of rollback and rollforward procedures in order to solve the problems of the prior art with respect to locks and preemption. If a rollback section of user code is interrupted, for whatever reason, the kernel causes a “roll back” to the first instruction in the section. That is, after the interrupt has been serviced, when control is returned to the interrupted user-level thread, execution resumes at the beginning of the rollback section, not at the point in the rollback section where the interrupt occurred.

A consequence of employing rollback sections is that when the last instruction in a rollback section is executed, it is necessarily the case that the entire path (however varied) from first instruction to last instruction was executed without interruption. This has two subsidiary consequences. First, because the kernel does not “unmap” a page of shared memory while user-level code is executing, no page of shared memory touched during the uninterrupted execution will have been unmapped during such execution. Second, the time between execution of the first instruction and execution of the last instruction in a rollback section is bounded.

If a rollforward section of user code is interrupted, for whatever reason, the kernel causes execution to “roll forward” through the section to the last instruction. That is, the kernel essentially suppresses interrupts within a rollforward section, delaying the servicing of any interrupt until the section completes.

The present invention enables the creation (and availability to user code) of, among other structures and associated algorithms, a species of “queued spinlock” that both is strictly “fair” and has all of the advantages of a lock for ease of operating on shared data structures. Thus, a developer skilled in the art can use this spinlock to intuitively create routines that safely operate on such structures with the following paradigm: lock, thereby excluding all other threads; manipulate the structure without complicated lock-free operations; unlock.

Crucially, the present invention-powered spinlocks have none of the disadvantages of traditional locks: they formally fit the definition of “lock-free” code. See, e.g., https://en.wikipedia.org/wiki/Non-blocking_algorithm #Lock-freedom. Indeed, they are better than lock-free; they are “wait-free,” which is “the strongest guarantee non-blocking of progress.” https://en.wikipedia.org/wiki/Non-blocking_algorithm #Wait-freedom. The embodiments of the present invention and_lock_acquire_value( ) and and lock_release_value( ) illustrated and described herein implement a version of a wait-free spinlock based on the array-based Anderson lock. See, e.g., https://geidav.wordpress.com/2016/12/03/scalable-spinlocks-1-array-based/.

As another example, using the aforementioned queued spinlocks and other aspects of the invention, the invention enables the creation (and availability to user code) of multi-producer, multi-producer queues and associated algorithms that operate on data of unlimited size, that require no memory reclamation (e.g., hazard pointers), and that nevertheless outperform existing queue algorithms.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 depicts a prior art multicore system employing lock on a common data structure;

FIG. 2 illustrates a process followed during execution of a rollback section of user code;

FIG. 3 depicts a process followed during execution of a rollforward section of user code;

FIG. 4 depicts a user routine making use of the present invention, including both rollback and rollforward sections, to enqueue data to a wait-free queue enabled by the present invention;

FIG. 5 illustrates a user routine making use of the spinlock routines in FIG. 4 and other aspects of the present invention, including a rollforward section, to dequeue data from a wait-free queue enabled by the present invention;

FIG. 6 illustrates user routines acquiring and releasing a wait-free spinlock enabled by the present invention;

FIG. 7 illustrates a process for a kernel interrupt handler for handling maskable interrupts;

FIG. 8 depicts a process for a kernel interrupt handler for handling non-maskable interrupts;

FIG. 9 illustrates a process for a kernel interrupt handler for handling page faults; and

FIG. 10 depicts a system in accordance with the present invention.

### DETAILED DESCRIPTION OF THE INVENTION

To take advantage of multiple cores and otherwise to function effectively, multiple distinct threads of code of a single application that are simultaneously executing on the multiple cores must communicate with each other. They typically do so through so-called shared data structures—i.e., organized data that is located in the application's shared memory and therefore accessible by all threads. Prominent examples of these shared data structures are stacks, queues, deques, and linked lists.

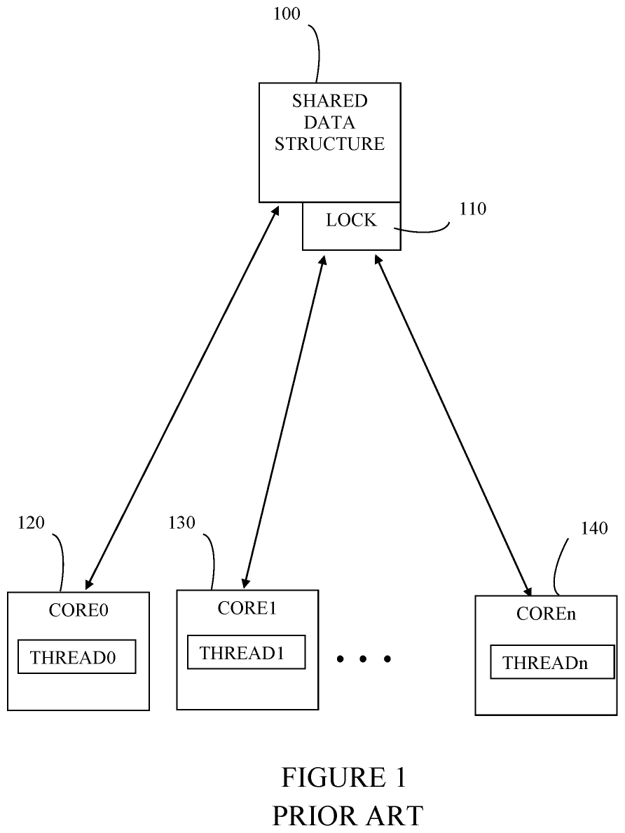

To preclude corruption of the data by simultaneous conflicting operations (from different threads), access to the shared data structures must be arbitrated. A familiar means of preventing conflicts is a lock, by which one thread can exclude all others from access to the structure while that thread executes a critical section of instructions that read from or write to the structure or both. The lock is initiated by the thread/CPU wanting to read from or write to these common data structures, e.g., stacks or queues. As illustrated in FIG. 1, three cores/threads. 120-140 share a common data structure 100 in the memory of the system. When thread0 120 is executing a particularly critical section of its instructions that reads from or writes to (or both) the common structure, it places a lock 110 on the data structure 100 to prevent thread1 130 or thread2 140 from writing to the data structure 100. In a normal operation, once thread0 120 has completed its operation involving the data structure 100, it removes the lock 110 to allow the other threads access to the data structure 100.

However, locks have several disadvantages that result from the preemption process discussed above. If a thread is preempted by the kernel while it holds a lock protecting a shared data structure, all progress vis-à-vis the data structure is blocked while that thread is suspended (preempted). The suspended (preempted) thread is, by definition, making no progress, and all other threads are locked out of the shared data structure. To mitigate this problem, software designers have invented various “lock-free” algorithms for manipulating shared data structures. These algorithms, however, must confront the same problem of preemption, namely, that they may be interrupted at any time for an unbounded length of time. Consequently, lock-free algorithms can be surprisingly complex and can employ numerous hardware-synchronizing instructions that slow them down considerably relative to their lock-based counterparts.

An example of a lock-free algorithm is the well-known Treiber stack (https://en.wikipedia.org/wiki/Treiber_stack). The Treiber stack algorithm is a scalable lock-free stack that utilizes a fine-grained concurrency primitive compare-and-swap. The basic principle for the algorithm is to only add something new to the stack once it is known that the item you are trying to add is the only thing that has been added since the operation began. This is done by using an operation called compare-and-swap. Pushing an item to the stack is done by first taking the top of the stack (old head) and placing it after your new item to create a new head. You then compare the old head to the current head. If the two are matching then you can swap the old head to the new one; if not then it means another thread has added an item to the stack, in which case you must try again. When popping an item from the stack, before returning the item it must be verified that another thread has not added a new item since the operation began.

Code that is executed as part of the operating system (or kernel) can mitigate these pathologies by temporarily disabling preemption, i.e., by masking many (though not all) interrupts. However, code that is executed in user mode (e.g., regular applications like web browsers and e-mail clients) has no such ability to mask interrupts.

In one embodiment of the present invention, the problem of preemption described above is solved by providing user applications with a library of preemption-defying routines. In a preferred embodiment, this library of preemption-defying routines is provided by the kernel. In this preferred embodiment, the same code is provided by the kernel to every application and the kernel is able to recognize when one of these preemption-defying routines is being run by one of the user applications. In a preferred embodiment, the code for this library of preemption-defying routines is stored in a common memory provided by the kernel. Recognizing that the code it previously provided to an application is being run, the kernel guarantees that the critical sections in which these routines manipulate shared data structures are not preempted, or if there are any interrupts, the kernel guarantees that any interruption is brief and bounded, so that every critical section is able to complete in a strictly bounded time. The kernel fulfills this guarantee by enforcing rollback sections and rollforward sections (described below) with supportive fault handling. The kernel provides these guarantees without the user routines (applications) having to make system calls to the kernel or without otherwise incurring (in the overwhelming majority of cases) the severe slowdown caused by crossing the user-kernel boundary.

A rollback section (also known as a “restartable sequence”) is a section of code, a routine, in a user application as to which the kernel causes execution to “roll back” to the first instruction in the section if the code is, for any reason, interrupted at any point within the section. That is, when the kernel returns control to the interrupted user-level thread, execution resumes at the beginning of the rollback section, not the point at the point in the rollback section where the interrupt occurred. Optionally, a rollback section can be configured so that the kernel causes the interrupted thread to resume execution at a designated out-of-section handler, which can conditionally jump back to any point within the section.

A rollback section is known in the prior art. For example, the Linux operating system implements rollback code and calls them “restartable sequences”, see https://lwn.net/Articles/883104/. Similarly, MacOS/iOS has recently started to support “restartable userspace functions” which is believed to embody rollback sections. The rollback sections of the present invention are different from that of the Linux kernel, in that it is optimized to work together with rollforward sections as described below.

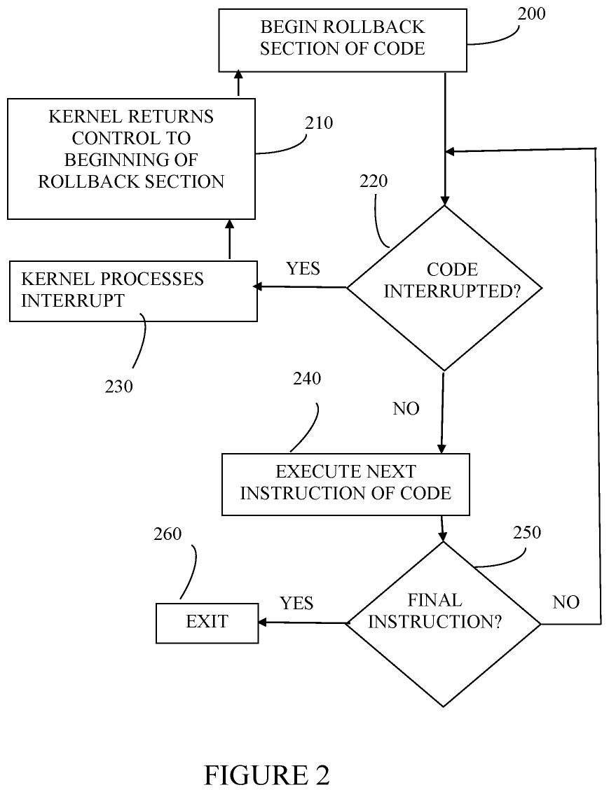

FIG. 2 illustrates the process followed when executing a rollback section of instructions in a user thread. In step 200, the thread begins execution of the rollback section of code, denoted as a designated code or a designated routine. As described above, the rollback section of instructions can either be inline in a user's routine or be in a section of memory provided by the kernel. In step 220 it is determined whether or not the user's routine has been interrupted. As appreciated by those skilled in the art, this determination does not require any instructions/code in the user's routine; rather execution of the instructions in the user thread is literally interrupted/stopped when the core receives the interrupt.

If a user routine is interrupted, the YES path out of query 220, the kernel processes whatever action is to be performed that required the initiation of the interrupt in the first place. This action to service the interrupt is performed in step 230. Although there is a plethora of interrupts, the interrupts generally fall into one of three types: hardware interrupts; software interrupts; and exceptions. Hardware Interrupts. When a hardware device wants to tell the Central Processing Unit (CPU) that certain data is ready to process (e.g., a keyboard entry or when a packet arrives at the network interface), it sends an interrupt request (IRQ) to signal the CPU that the data is available. Software interrupts. When playing a video, it is essential to synchronize the music and video playback so that the music's speed doesn't vary. This is accomplished through a software interrupt that is repetitively fired by a precise timer system. This timer enables a music player to synchronize. A software interrupt can also be invoked by a special instruction to read or write data to a hardware device. Exceptions. An example of an exception is when the CPU executes a command that would result in division by zero or a page fault, any additional execution is interrupted.

In step 210, the kernel returns control to the user thread back to the beginning of the rollback section. As described below, alternatively, the kernel can return control to a special handler section. This handler section can return control to the beginning of the rollback section as indicated FIG. 2 or continue execution at a different part of the rollback section or to a completely different portion of the user thread.

If there is no interrupt of the user thread, the NO path out of query 220, execution of the usual routine proceeds to the next instruction in the rollback section of the code. After execution of this instruction a determination is made in step 250 as to whether or not that instruction is the final instruction of the rollback section. If it is not, control loops back to the query in step 220 and execution of the code continues instruction by instruction, and handling of interrupts proceeds as described above. If it is determined step 250 that the final instruction in the rollback code has been executed, the user thread exits the rollback section of code at step 260.

A consequence of employing these rollback sections is that when the last instruction in a rollback section is executed, it is necessarily the case that the entire path (however varied) from first instruction to last instruction was executed without interruption. This has two subsidiary consequences. First, because the kernel does not “unmap” a page of shared memory while user-level code is executing, no page of shared memory touched during the uninterrupted execution will have been unmapped during such execution. Second, the time between execution of the first instruction and execution of the last instruction in a rollback section is bounded.

A rollforward section of the present invention is a section of code as to which the kernel causes execution to “roll forward” through the section (executing the code in the section) to the last instruction if the code would otherwise be interrupted at any point within the section. That is, the kernel essentially suppresses interrupts within a rollforward section, delaying the servicing of any interrupt until the section completes. The most efficient method by which the kernel detects a rollforward section in user code is for the kernel to provide the code to every user application at a fixed memory address. When the kernel initiates an interruption of a section of code it simply needs to check whether the interruption took place inside that block of code, e.g., (intr_addr>=block_begin) && (intr_addr<=block_end). Alternatively, the kernel can keep track of the differing addresses of the blocks of rollforward sections in each application and use those application-specific addresses for the address test above.

If execution in a user application reaches the first instruction in a rollforward section, the entire path (however varied) from first instruction to last instruction of the rollforward section is executed without any but a brief and strictly bounded interruption (or until the kernel “panics,” as described below). A consequence of this methodology is that, in the absence of an infinite loop, the time between execution of the first instruction and execution of the last instruction in a rollforward section is bounded.

Servicing of interrupts during the time it takes to execute a rollforward section of code can be delayed for a “long time”—but not forever. Accordingly, a truly infinite loop in a rollforward section causes a kernel “panic.” The kernel creates a panic when one kernel thread is waiting for all other kernel threads to respond to a critical interprocessor interrupt, e.g., to manipulate the virtual memory system. That thread will wait only so long before deliberately “crashing” the system and restarting with an error message. As a practical matter, this is not a problem because the kernel notifies the user routine whenever it has resumed the routine after an interruption. The routine can check for this notification during each iteration of a loop and respond thereto by cleaning up (e.g., releasing a lock) and gracefully exiting the rollforward section, at which time the delayed interrupt is serviced.

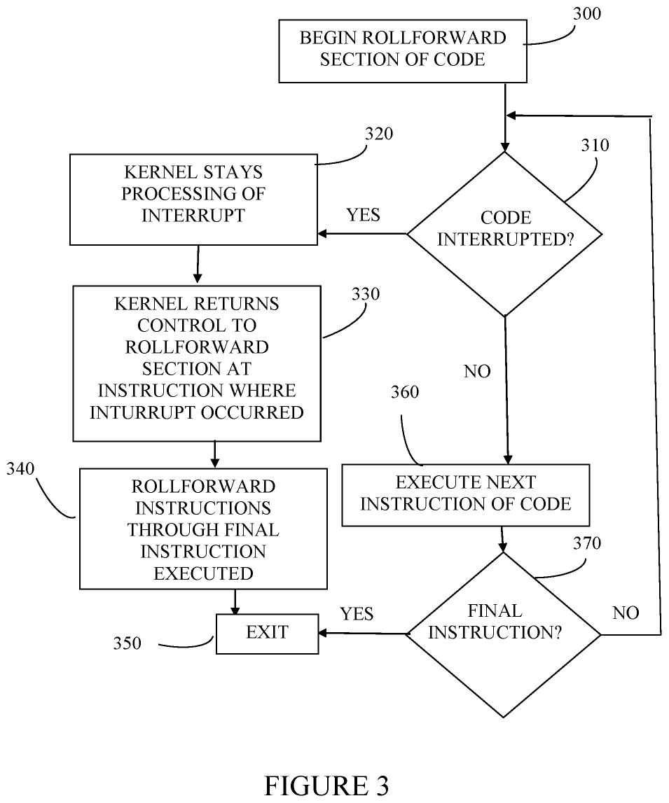

FIG. 3 illustrates the process followed for executing a rollforward section of instructions in a user thread. In step 300, the thread begins execution of the rollforward section of code. As described above, the rollforward section of instructions can either be inline in a user's routine or be in a section of memory provided by the kernel. In step 310 it is determined whether the user's routine has been interrupted. As appreciated by those skilled in the art, this determination does not require any instructions/code in the user's routine, rather execution of the instructions in the user thread is literally interrupted/stopped when the core receives the interrupt. As further described below, a true interrupt (as opposed to an exception) is asynchronous, meaning that (from the thread's perspective it “just happens out the blue.” That is, the CPU is executing instructions in user code and then (at basically any time) it starts executing instructions in the kernel, specifically in an interrupt handler. The invention has modified the interrupt handler to determine whether previous execution was in a rollforward section. If so, the previous execution is in a rollforward section, the handler resumes the user code before actually handling the interrupt, as described in detail below. Thus, execution of user code is in fact interrupted briefly, typically on the order of a couple dozen machine instructions, but that brief interruption is essentially transparent to the user code.

If the rollforward section of code, denoted as a designated code or a designated routine, is interrupted/stopped, the YES path out of query 310, in step 320 the kernel stays or forebears from acting on whatever action is to be performed that required the initiation of the interrupt in the first place.

In step 330, the kernel returns control to the user thread back to the rollforward section at the instruction where the interrupt occurred. As described in step 340, the entire rest of the rollforward instructions are executed until the final instruction is executed. In step 350 the rollforward section of code is exited.

Rollback and rollforward sections may be used independently, but they are most powerful when the former immediately precedes the latter. As further described below, this embodiment yields one long sequence of code that is effectively uninterrupted and that can (in many cases) access memory without fear of page faults.

The present invention takes special account of page faults, which occur when a program requests an address on a page that is not in the current set of memory resident pages. Routines may specify that a given memory access in a rollback section that would otherwise cause a fatal page fault instead cause execution to roll back as if there had been an interrupt. This feature of the present invention enables the routine to seamlessly restart the section with non-stale data and eliminates the need for complicated memory reclamation techniques (e.g., hazard pointers).

Any fault within a rollforward section, including a page fault that might otherwise be successfully handed by the virtual memory system, ordinarily causes a fatal exception. In most cases when the present invention is employed, page faults do not pose a problem, given (as noted above) that any page touched in a rollback section that immediately precedes a rollforward section remains mapped until the latter completes. Moreover, routines may specify that a given memory access in a rollforward section that would otherwise cause a page fault instead invoke a within-section handler, whose task is to clean up (e.g., release a lock) and then exit the section gracefully in order to handle the fault.

In a further embodiment of the present invention, a rollback section immediately followed by a rollforward section has an additional feature when the instruction at the boundary of the two sections is a conditional branch (e.g., ‘jne [label]’ in the x86 architecture). This conditional branch typically follows a compare-and-swap operation that makes an initial modification to a shared data structure (e.g., ‘cmpxchg’ in the x86 architecture). In that situation, the rollforward section is entered if and only if the operation is successful (e.g., if ZF is set in the x86 architecture). This feature enables various optimizations to the preemption-defying routines.

The present invention has a further embodiment, which relates to operating systems that support hardware-assisted virtualization. In a hardware-assisted virtualization environment, a virtual machine (VM) (or guest) is directed by a hypervisor (or host). In this aspect, threads of execution inside a virtual machine (VM threads) are analogous to the user-level threads described above. The present invention enables operating systems to provide VM threads access to a library of routines that employ rollforward sections, either alone or in conjunction with rollback sections. Such sections enable these VM thread-accessible routines to execute critical sections that effectively cannot be subjected to a VM exit (a species of interruption in which control is returned from the virtual machine to the hypervisor)—all without incurring the severe slowdown of making a hypercall or otherwise (in the overwhelming majority of cases) crossing the guest-host boundary.

In this embodiment, a rollback section is a section of code as to which the hypervisor causes execution to roll back to the first instruction if the code is for any reason subject to a VM exit at any point within the section. That is, when the hypervisor returns control to the interrupted VM thread, execution resumes at the beginning of the rollback section. Optionally, a rollback section can be configured so that the hypervisor causes the interrupted thread to resume execution at a designated out-of-section handler, which can conditionally jump back to any point within the section. Otherwise, the rollback section is the same as described above.

In this embodiment of the invention, a rollforward section is a section of code as to which the hypervisor causes execution to roll forward through the section to the last instruction if the code would otherwise be subjected to a VM fault at any point within the section. That is, the hypervisor essentially suppresses VM exits (other than those caused by faults) within a rollforward section, delaying the servicing of any VM exit until the section completes. Otherwise, the rollforward section is the same as described above.

The kernel makes preemption-defying routines available to user-level code (either all applications or only those that request them). These preemption-defying routines, such as rollback and rollforward routines have the characteristics and guarantees described above. In a secure environment, these routines are supplied by the kernel on a read-only basis. In a non-secure environment, the kernel may treat as preemption-defying certain routines supplied by one or more applications on an ad-hoc basis.

In a secure environment, the kernel also supplies a read-only copy of the rollforward sections of the subject routines, to be executed after the kernel “resumes” code interrupted within a rollforward section (as described below). In a non-secure environment, the copy may be supplied by the application. In either environment, the copy may be exact (in which case the code must execute differently depending on whether it is executing before or after the interruption) or close (in which case each version is optimized to execute in its respective context; e.g., each version jumps unconditionally when it is appropriate and execute a no-op when it is not).

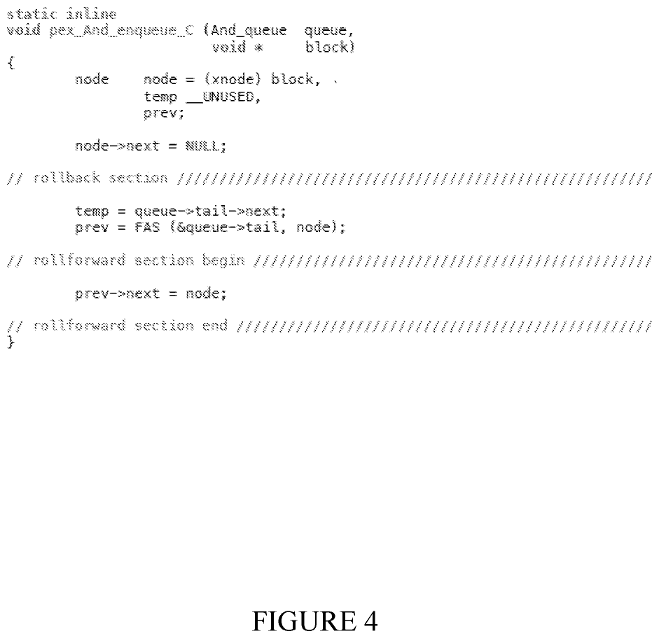

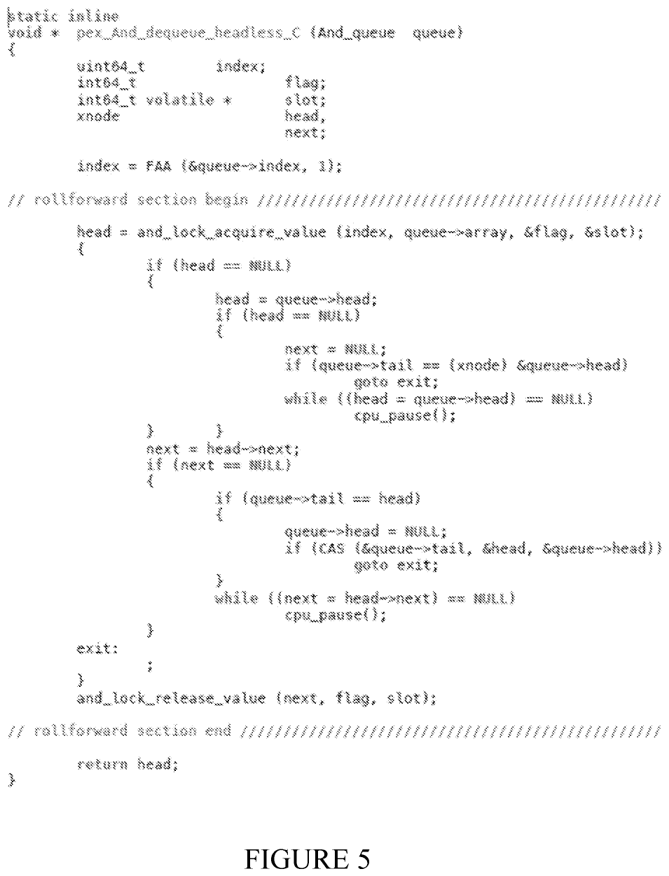

Illustrated in FIGS. 4 and 5 are software routines that use the spinlocks of the present invention (as well as other aspects of the invention) to create a wait-free queue and its two operations, pex_And_enqueue( ) and pex_And_dequeue( ) Although one could use the above-stated paradigm—lock; enqueue or dequeue; unlock—these algorithms are faster because the enqueue algorithm requires no lock. Although the dequeue algorithm looks comparatively complicated, it is in fact very simple whenever the queue has at least two elements (i.e., when head and next are non-NULL). In that situation, the algorithm boils down to: lock; read next node; unlock. And the queue requires no hazard pointers, memory reclamation, or other complicated operations to work, and it operates on blocks of data of any size. All told, for this type of queue, the present invention create an incredibly fast queue.

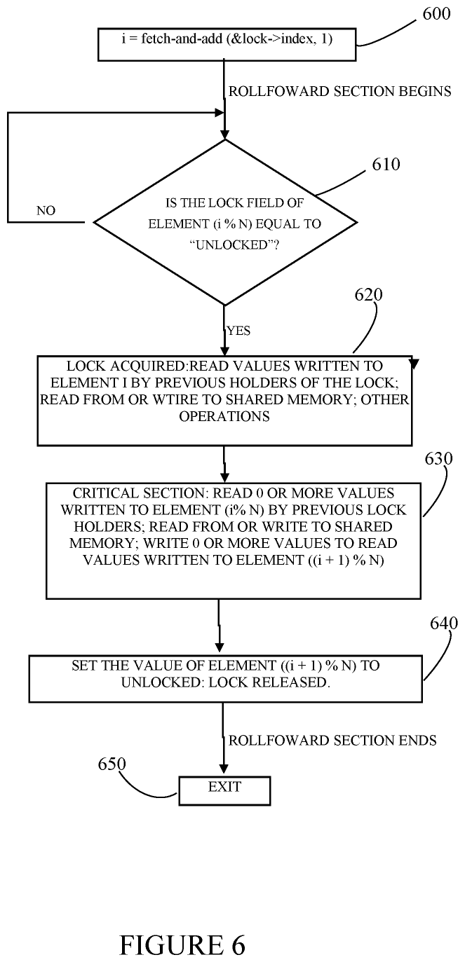

FIG. 6 illustrates, flowchart form, the process for using a spin lock as illustrated in FIG. 5.

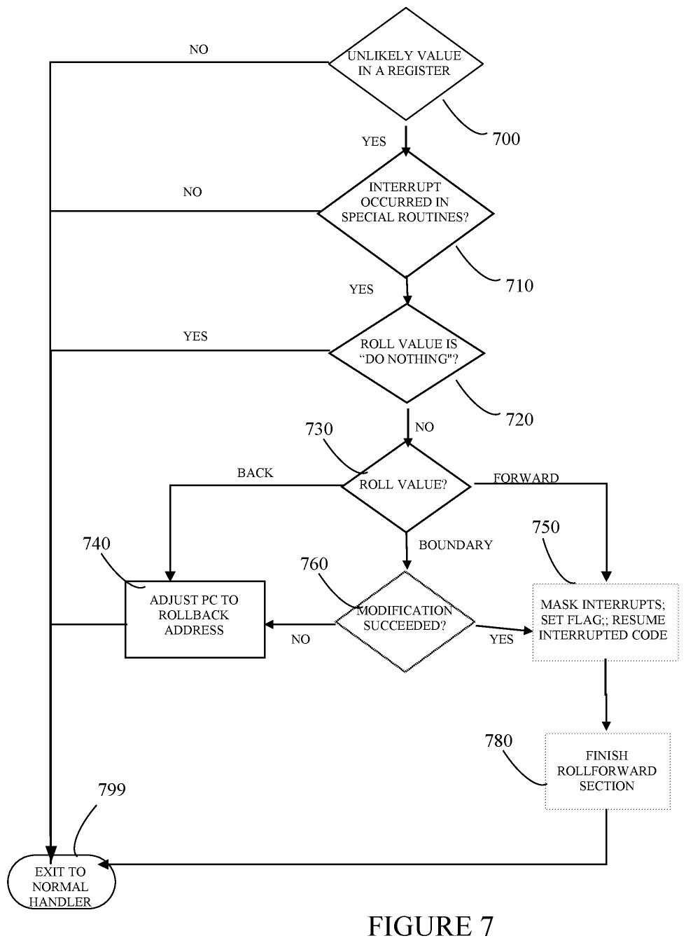

As part of its exception-processing superstructure for handling hardware and software exceptions, the kernel employs various handlers as discussed below and illustrated in FIGS. 7-9. All of these handlers share common features, as described in the following paragraph. As appreciated by those skilled in the art, the handlers are the code in the kernel that process the various interrupts, faults, and exceptions of the user code as required for the operation of the system.

As an optimization, as illustrated for example in FIG. 7, step 700, each handler determines whether one or more registers or regions of memory of the excepted thread contain one or more “unlikely” values. An unlikely value is a value that is very unlikely to ever appear except deliberately in one of the preemption-defying routines because it is (1) not a valid pointer to a routine or data larger than one byte and (2) not series a characters that would ever appear in a human-language string. For example, on x86 machines, the kernel checks whether register r11d contains the 32-bit value 0xd2c49ef3; it has a one-in-a-billion chance of happening except on purpose. That makes it an almost perfect test of exclusion.

An unlikely value indicates that the thread was executing the subject routines or copies of rollforward sections. If the registers do not contain any of the these “unlikely” values, the kernel handler exits its special handling routine. Having ascertained the address of the excepted code, as provided by the underlying hardware in an architecture-specific manner, the handler determines whether such address falls within the continuous range of the subject routines. This range may be the same for all applications or differ on an application-by-application basis. If the address falls outside that range, the kernel handler exits its special handling routine.

From this point, the various handlers diverge in their operation. As specified below, the various handlers must handle: (1) maskable interrupts; (2) non-maskable interrupts; (3) page faults; (4) debug exceptions; and (5) other exceptions.

(1) Returning to FIG. 7, each of the kernel interrupt handlers first performs a check, 700, as to whether or not there is an unlikely value in a register of the excepted thread. If there is no unlikely value in this register, the handler is exited, step 799, and returned to the normal interrupt handler. The kernel employs one or more interrupt handlers, encompassing all maskable asynchronous interrupts (e.g., periodic timers or interprocessor signaling), with the following features. As illustrated in step 710 the handler determines if the interrupt occurred in 1 of the present invention's special routines. Whether separately or by means of common code, these interrupt handlers determine whether an interrupt occurred: (i) in a rollback section; (ii) in a rollforward section; (iii) on the boundary between them; or (iv) at none of the foregoing. In a non-secure environment, this determination may be based on the values of one or more registers or regions of memory of the interrupted thread. In a secure environment, this determination is based on values that cannot be manipulated by the application. It is determined that the interrupt is not in a special routine, control is returned to the normal interrupt handler at step 799.

One mechanism for making a secure determination is a lookup table in read-only memory that returns a distinct value for every distinct address within the continuous range of the subject routines. On architectures with variable instruction lengths, the table accounts for the possibility that code was interrupted at an address not intended by the author of the routine to be an instruction boundary, in which case the table returns the value “(iv) none.”

In step 720. a test on the returned roll value is made see if it indicates “do nothing.” This state reflects that the value returned for an instruction that is in neither a rollback section nor a rollforward section, typically near the very beginning of the routine or the very end. If it is determined that the value indicates that interrupt occurred in a “do nothing” section rather than a rollback or rollforward section, “YES” out of step 720, control is returned to the normal interrupt handler at step 799. If the value returned is not “do nothing,” the process continues to step 730.

If the determination in step 730 is made that the interrupt occurred in a “(i) rollback section,” the handler (in an architecture-specific manner) in step 740 sets the address to which the kernel returns control to the interrupted user-level thread to the routine's “rollback address,” and then exits special handling at step 799. As described above, the rollback address is typically the beginning of the rollback section, though it may be otherwise. The rollback address, which may be optimized for space as simply an offset within the continuous range of the subject routines, may be specified in a register, in the thread's memory, or otherwise. One method is to specify the rollback address (or offset) in a register (or portion thereof) reserved by the subject routines for purposes of the invention.

If the determination in step 730 is made that the interrupt occurred in a “(ii) rollforward section,” the handler prepares to resume the interrupted code in step 750. In all implementations, this includes restoring all registers of the interrupted thread and ensuring to the maximum extent possible that further interruptions (including, in some implementations, debug exceptions) are disabled (i.e., masked). In a secure environment, the handler modifies certain registers that may be used to access shared memory, so that such registers do not access memory reserved to the kernel (e.g., by clearing the most significant bit of the register).

Once the handler determines the interrupt occurred in a rollforward section, it resumes the interrupted code at step 750 until the rollforward section is finished at step 780. In a non-secure environment, this might involve returning to user-mode execution; otherwise, execution remains in kernel mode. As described above, in some implementations, control is returned to an exact copy of the interrupted rollforward section; in that case, the kernel sets a flag (e.g., a bit in a reserved register) to notify the routine that it has been interrupted and resumed. In other implementations, control is returned to a close copy that is optimized for this purpose, and no such flag is necessary.

In the absence of a synchronous exception during subsequent execution in the rollforward section (and subject to non-maskable interrupts, as discussed below), execution completes the rollforward section of the interrupted routine in step 780 without further interruption. At that point, control returns to the special interrupt handler. The handler takes appropriate steps to return everything to a “normal” state (e.g., restoring status flags and re-enabling interruptions and debugging exceptions). After these steps, the handler exits special handling in step 799 and returns control to the normal interrupt handler to handle the deferred interrupt.

If the determination in step 730 is that the interrupt occurred “(iii) on the boundary,” the handler (in an architecture-specific manner) determines in step 760 from a status register or otherwise whether the rollback section's modification to the shared data structure succeeded. If so, the handler treats the instruction as within a rollforward section and proceeds to step 750; if not, as within a rollback section and proceeds to step 740.

If the determination is that the interrupt occurred in “(iv) none,” which is synonymous with “do nothing” as described above, the handler exits special handling.

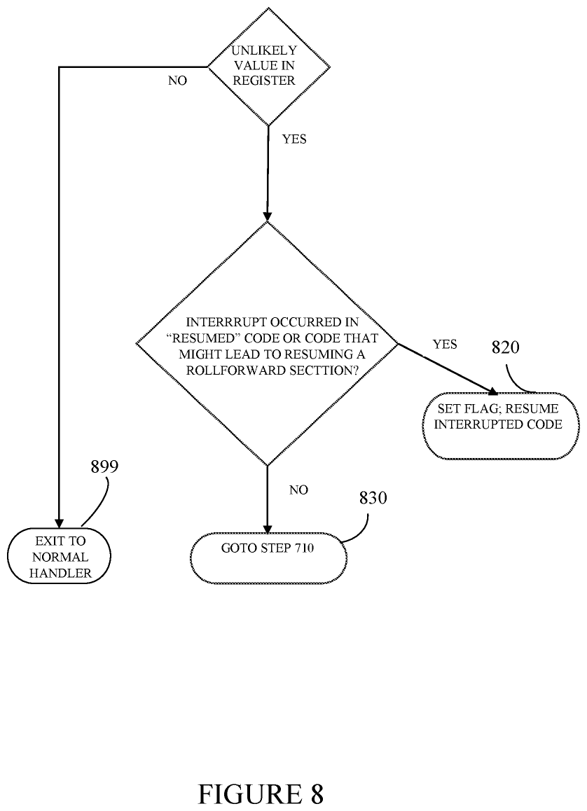

(2) Certain combinations of architectures and operating systems employ so-called “non-maskable interrupts” (NMI). In such configurations, as illustrated in FIG. 8, the kernel employs an NMI handler with the following features. As with the process described above in FIG. 7, the kernel interrupt handler first performs a check, 800, as to whether or not there is an unlikely value in a register of the excepted thread. If there is no unlikely value in this register, the handler is exited, step 899, and returned to the normal interrupt handler. The NMI handler determines in step 810 whether the NMI interrupted code in a “resumed” rollforward section (or in a code path, perhaps within another handler, which might lead to resuming a rollforward section). If interrupt did not occur in a “resumed” rollforward section, the NMI handler exits special handling in step 830 and goes to the maskable interrupt handling in step 710. If the interrupt did occur in a rollforward section, the handler in step 820 sets a flag to indicate that the NMI must be handled later and immediately resumes the interrupted code path with the appropriate restored state. When control returns to the NMI handler—whether after completion of a rollforward section or otherwise—the NMI handler ensures that the NMI is handled before any other action is taken by the kernel (e.g., handling a maskable interrupt or a fault). Afterwards, the NMI handler exits its special handling routine.

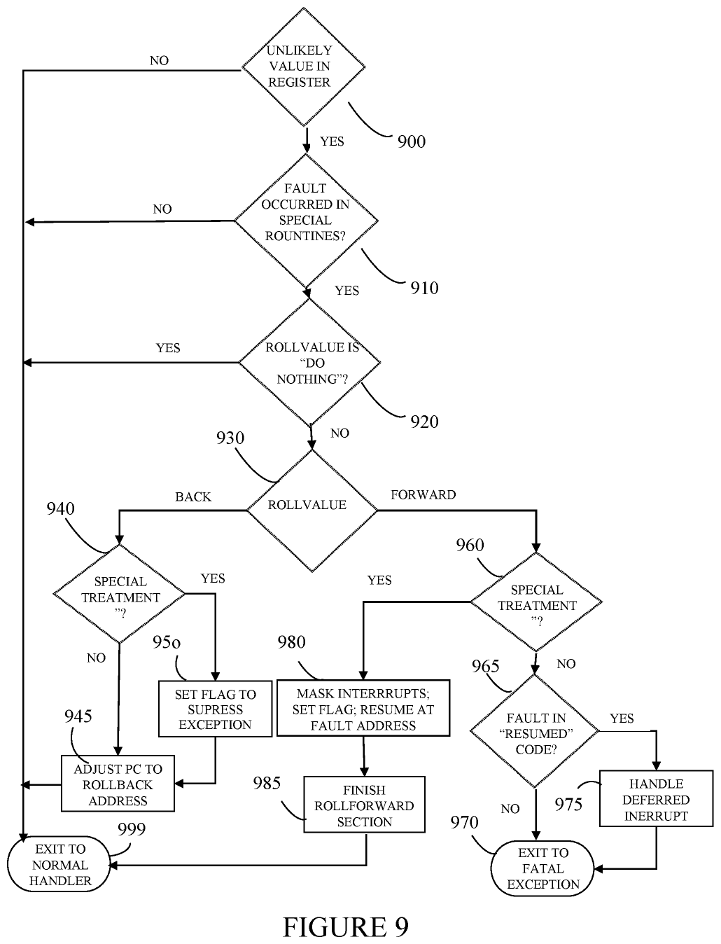

(3) As illustrated in FIG. 9, the kernel employs a page fault handler with the following features. The page fault handler determines whether an interrupt occurred: (i) in a rollback section; (ii) in a rollback section, with special treatment indicated; (iii) in a rollforward section; (iv) in a rollforward section, with special treatment indicated; or (v) at none of the foregoing. The processes in steps 900-930 are essentially the same as described above with respect to FIG. 7.

If the determination in step 930 is made that page fault occurs in a “(i) rollback section,” the page fault handler (in an architecture-specific manner) first determines in step 940 if there is any special treatment associated with the handling. If not, in step 945, the kernel sets the address to which the kernel returns control to the interrupted user-level thread to the routine's “rollback address,” and then exits special handling (similar to the other interrupt handlers described above) in step 999. As an optional aid to debugging, the handler may provide a mechanism by which the actual fault address is restored when the page fault cannot be resolved by the virtual memory subsystem, such that kernel's exception reporting subsystem reports that address (rather than the rollback address).

If the determination in step 940 is made that page fault occurs in a “(ii) rollback section, with special treatment,” the handler likewise sets, in step 945, the address to which the kernel returns control to the interrupted user-level thread to the routine's “rollback address.” The handler also ensures in step 950 that when the page fault cannot be resolved by the virtual memory subsystem, the exception is ignored (suppressed), such that execution seamlessly restarts at that address.

If the determination is made in step 930 that page fault occurs in a “(iii) rollforward section,” and it is further determined in step 960, that there is no special handling involved, the handler first determines in step 965 if the fault occurred in “resumed” code. If the fault is not in “resumed” code, the handler ensures that the kernel's exception reporting subsystem immediately reports a fatal exception in step 970, regardless of whether the page could be resolved by the virtual memory subsystem. If the fault occurs in rollforward code that had previously been “resumed” after a previous interrupt that had been deferred (YES out of step 965), the kernel handles the deferred interrupt, step 975, and reports the fatal exception in step 970.

If the determination is made that page fault occurs in a “(iv) rollforward section, with special treatment,” “YES” out of step 960, the handler in step 980 sets a flag to indicate that the page fault must be handled later, and the handler resumes the rollforward section (similar to the maskable interrupt handlers described above) at an address specified the routine. Execution continues until the rollforward section is finished, step 985. One mechanism for making a secure determination of that address is to resume execution at pre-determined offset from the faulting instruction, which resumed instruction would jump to the specified address. When control returns to the special fault handler, it ensures that (after any deferred interrupt is handled) the fault is then handled by the virtual memory subsystem. As an optional aid to debugging, the handler may provide a mechanism by which the actual fault address within the rollforward section is restored when the page fault cannot be resolved by the virtual memory subsystem, such that kernel's exception reporting subsystem reports that address (rather than the address at the end of the rollforward section).

If the determination is made that page fault occurs in a “(v) none,” the page fault handler exits its special handling routine.

(4) The kernel employs one or more debug exception handlers with the following features. In some implementations, these handlers treat debug exceptions like interrupts (similar to the maskable interrupt handlers described above), such that exception handling is deferred until after rollback or rollforward. In other implementations, these handlers treat debug exceptions as an indication that the exception should be handled immediately notwithstanding that exception occurred during execution of a rollback section or a rollforward section. In the latter case, if the exception occurs during a resumed rollforward section, the handler takes appropriate steps to return everything to a “normal” state and to handle any deferred interrupt.

(5) The kernel employs additional exception handlers. At a minimum, these handlers encompass any exception that could be generated by data supplied by the caller of the subject routines, e.g., a “general protection fault” in the x86 architecture or a divide-by-zero error. Optionally, these handlers may encompass exceptions generated solely by the subject routines, e.g., an undefined instruction error. In all cases, the handlers take appropriate steps to return everything to a “normal” state and to handle any deferred interrupt before handling the exception itself.

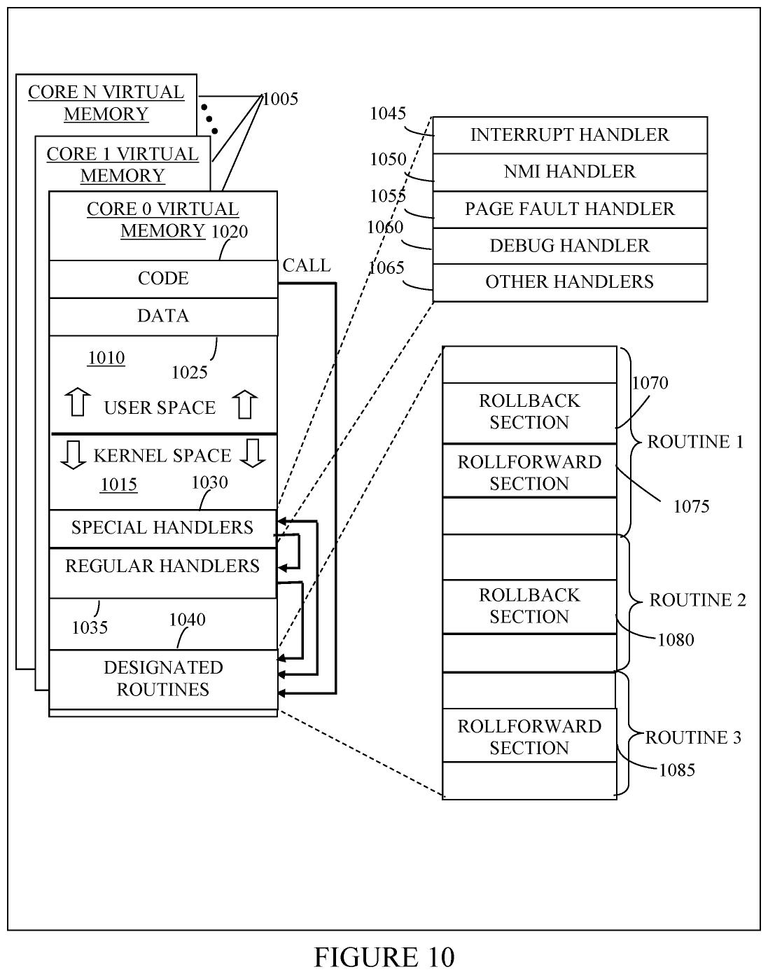

FIG. 10 illustrates a system in accordance with the present invention. Specifically FIG. 10 illustrates the allocation of system memory 4 several cores 1005, Core 0, Core 1 through Core N. The virtual memory in each of the Cores 0-N is divided between a User Space 1010 and a Kernel Space 1015. Although illustrated only with respect to Core 0, as appreciated by those skilled in the art, all of the Cores 0-N share a common kernel (operating system) space 1015, but each of the Cores 0-N have their own unique user space 1010 where they run their own unique threads. As further appreciated by those skilled in the art the system 1000 of the present invention can be embodied upon a single chip with the Cores 0-N connected by a bus along with the other hardware elements that comprise the system. Also appreciated by one skilled in the art, each of the elements could be emulated by virtual elements and embodied in the cloud, which would obviate the need for physical elements such as the bus.

In the preferred embodiment, the kernel space 1015 includes at least two categories of interrupt handlers-Special Handlers 1030 and Regular Handlers 1035. As described above, the Special Handlers 1030 are invoked when an interrupt occurs during the execution of one of the Designated Routines 1040. As illustrated in FIG. 10, if no special handling is required once the Special Handlers 1030 are invoked, control is passed to the Regular Handlers 1035 to handle the interrupt.

As further illustrated in the breakout of the Special Handlers 1030 in FIG. 10, the Special Handlers 1030 include a standard interrupt handler 1045, a non-maskable interrupt handler 1050, a page fault handler 1055, a debug handler 1060 and other handlers 1065. These handlers 1045-1065 perform the functions as previously described in regard to the specific type of interrupt being processed.

As described above, when the Code 1020 running the user's thread requires uninterrupted operation or undisturbed state of a common resource such as a shared data structure in Data 1025, the Code 1020 calls one of the Designated Routines 1040.

As depicted in the breakout of the Designated Routines 1040, FIG. 10 includes three different routines the user Code 1020 can call. In the embodiment illustrated in FIG. 10, Routine 1 includes a Rollback section of code 1070 immediately followed by a Rollforward section of code 1075. As described above, having back-to-back Rollback and Rollforward sections of code is a preferred embodiment. The Rollback code 1070 and the Rollforward code 1070 are both preferably provided by the kernel 1015. Further, as described above the kernel 1015 monitors for the execution of these designated sections of code, and in the event of an interrupt during execution of one of the Designated Routines 1040, performs one or more of the processes as described above with respect to FIGS. 2-9.

FIG. 10 further illustrates two additional Designated Routines 1040, Routine 2 and Routine 3. Routine 2 consists of a single Rollback section 1080. Although rollback section 1080 can be the same as rollback section 1070, it does not necessarily have to be the same. Similarly, Routine 3 includes a single Rollforward section 1085. Again, Rollforward section 1085 can, but does not have to be the same code as Rollforward section 1075. As further illustrated in FIG. 10, each of Routines 1-3 can have additional code apart from the rollback or rollforward sections, such as initialization code.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A process for handling interrupts in a kernel, the process comprising the acts of:
beginning execution of a designated section of code;
recognizing an interrupt occurred during the execution of the designated section of code, wherein the interrupt stops execution of the designated section of code;
postponing any action that would normally be performed to process the interrupt; and
restarting execution of the designated section of code at the point where execution was previously interrupted.

2. The process according to claim 1, further comprising:
after the execution of the final instruction in the designated section of code, the kernel executing an interrupt handler that would normally process the postponed interrupt.

3. The process according to claim 1, wherein the time between the beginning of the execution of the designated section of code and the end of the execution of the designated section of code is bounded.

4. The process according to claim 1, wherein the designated section of code is provided by the kernel.

5. The process according to claim 4, wherein the designated section of code is provided by the kernel in a common area of memory.

6. The process according to claim 5, wherein a user application executes the designated section of code in the common area of memory.

7. The process according to claim 1, wherein the designated section of code is denoted a rollforward section of code, the process further comprising:
prior to beginning the rollforward section of code, beginning execution of a rollback section of code;
recognizing an interrupt occurred during the rollback section of code, wherein the interrupt stops execution of the rollback section of code;
executing an interrupt handler to process the interrupt;
restarting execution of the interrupted rollback section of code at the beginning of the rollback section of code.

8. The process according to claim 7, further comprising:
executing the rollback section of code and the rollforward section of code contiguously.

9. The process according to claim 2, wherein the interrupt is a hardware interrupt.

10. A process for handling interrupts in a kernel, the process comprising the acts of:
recognizing an interrupt has occurred;
determining if the interrupt occurred during the execution of one of a plurality of designated routines;
if the interrupt did not occur during the execution of one of a plurality of designated routines, executing normal interrupt handling;
determining if the interrupt occurred during the execution of the plurality of designated routines denoted as a rollforward routine;
if the interrupt occurred during the execution of the rollforward routine:
masking the interrupt;
resuming the interrupted rollforward routine;
completing execution of the interrupted rollforward routine; and
executing the normal interrupt handling;

11. The process according to claim 10, further comprising:
determining if the interrupt occurred during the execution of another one of the plurality of designated routines denoted as a rollback routine;
if the interrupt occurred during the execution of the rollback routine:
setting an address to which the kernel returns;
executing the normal interrupt handling; and
after the normal interrupt handling is completed, returning execution to the previously set address.

12. The process according to claim 11, wherein the set address is the beginning of the rollback routine.

13. The process according to claim 11, further comprising:
determining that the interrupt occurred on a boundary between the rollback and rollforward routines;
determining if a modification to a shared data structure by the rollback routine was successful;
if the modification was successful, continuing the process as if the interrupt occurred during the rollforward routine; and
if the modification was not successful, continuing the process as if the interrupt occurred during the rollback routine.

14. The process according to claim 13, wherein the act of determining if the modification to the shared data structure was successful further comprises examining a status register.

15. The process according to claim 11, further comprising:
determining if the interrupt is a non-maskable interrupt;
if the interrupt is a non-maskable interrupt:
setting a flag to indicate that the non-maskable interrupt must be handled later;
resuming execution of the interrupted routine;
passing control to a non-maskable interrupt handler after completion of the execution of the interrupted routine; and
processing the interrupt by the non-maskable interrupt handler before any other action is taken by the kernel.

16. The process according to claim 10, further comprising:
determining if the interrupt is caused by a fault;
following the determination that the fault caused interrupt occurred during the execution of the rollforward routine:
determining if special handling of the fault caused interrupt is required;
if it is determined that special handling is required:
setting a flag to indicate that the fault caused interrupt must be handled later;
resuming execution of the interrupted rollforward routine;
completing execution of the interrupted rollforward routine; and
executing the normal interrupt handling;
if it is determined that special handling is not required:
determining if the fault occurred in the rollforward routine that had been previously resumed;
if the fault occurred in the rollforward routine that had been previously resumed:
executing the handling of the previously masked interrupt that had been postponed; and
reporting a fatal exception;
if the fault occurred in the rollforward routine that had not been previously resumed:
immediately reporting a fatal exception.

17. The process according to claim 11, further comprising:
determining if the interrupt is caused by a fault;
following the determination that the fault caused interrupt occurred during the execution of the rollback routine:
determining if special handling of the fault caused interrupt is required;
if it is determined that special handling is required:
setting a flag to suppress any exceptions caused by the fault;
setting an address to which the kernel returns; and
executing the normal interrupt handling.

18. The process according to claim 10, further comprising:
determining if a value in a specified register is an unlikely value; and
if the value is not an unlikely value, executing a normal interrupt handling.

19. The process according to claim 1, wherein a plurality of concurrent threads are executing, and the designated section of code is denoted a rollforward section of code, the process further comprising acts for creating, acquiring, using, and releasing a spinlock comprising:
within a single thread:
allocating an Anderson array-based spinlock having N elements, where N is a power of 2 not less than a maximum number of processors in the system;
initializing an index to 0, a value of a lock field of a first element to ‘locked’, and values of lock fields of all other elements to ‘unlocked’;
within any of the plurality of concurrently executing threads:
executing, immediately preceding the rollforward section of code, an atomic fetch-and-increment operation that increments the index;
reading, within the rollforward section of code, the value of the lock field of element (i % N), where i is the index returned by such operation;
repeating the reading act until such value is ‘unlocked’ whereby the spinlock is acquired;
resetting the lock field of element (i % N) to ‘locked’;
executing, within the rollforward section of code, a critical section protected by the acquired spinlock by a process comprising:
reading zero or more values written to the element by the previous holder of the spinlock;
reading from or writing to shared memory; and
writing zero or more values to element ((i+1) % N); and
releasing, within the rollforward section, the acquired spinlock by setting the value of the lock field of element ((i+1) % N) to ‘unlocked’.

20. The process according to claim 19 further comprising:
initializing the value of the first element to N, and the values of all other elements to their respective indices 1 to N−1;
repeating the reading act until the value is i;
omitting the resetting the value of element (i % N); and
releasing the acquired spinlock by setting the value of element ((i+1) % N) to (i+1+N).

21. A process for handling VM exits in a hardware-assisted virtualization environment, the process in a hypervisor comprising the acts of:
beginning execution of a designated section of code by a VM thread;
recognizing a VM exit occurred during the execution of the designated section of code, wherein the VM exit stops execution of the designated section of code;
postponing any action that would normally be performed to process the VM exit;
restarting execution of the designated section of code at the point where execution was previously interrupted.

22. A system for handling interrupts in a multicore processing environment comprising:
a plurality of cores, each of the plurality of cores executing within a virtual address space comprising a user space and a kernel space;
the user space comprising code and data;
the kernel space comprising at least one interrupt handler and at least one designated routine; wherein the at least one designated routine is called for execution by the code in the user space;
the interrupt handlers:
recognizing an interrupt occurred during the execution of the at least one designated routine, wherein execution of the designated routine is interrupted and execution resumes at the at least one handler;
postponing any action that would normally be performed to process the interrupt;
resuming execution of the designated routine at the point where execution was previously interrupted; and
ensuring that in the absence of a synchronous fault, the execution continues uninterrupted until the end of the designated routine.

23. The system according to claim 22, wherein plurality of processors are executing virtual machine threads and the kernel is a hypervisor overseeing execution of those threads.

24. The system according to claim 22 wherein the kernel includes regular interrupt handlers and special interrupt handlers and further wherein the special interrupt handlers induce a non-maskable handler, a page fault handler and a debug handler.

25. The system according to claim 22 wherein the virtual address space of the kernel space is common between all of the plurality of cores.
